(19) United States
(12) Patent Application Publication
(10) Pub. No.: US 2010/0261605 A1
(43) Pub. Date: Oct. 14, 2010

(54) Method and apparatus for processing work materials

(76) Inventors: Dennis N. Monahan, Fresno, CA (US); Elvin L. Haworth, Chowchilla, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 12/384,792

(22) Filed: Apr. 8, 2009

(51) Int. Cl. A01N 61/00; C05F 11/02; C05F 17/00; B09B 3/00; A01P 21/00; A01P 3/00; A01P 7/00

(52) U.S. Cl. 504/101; 71/23; 422/184.1

(57) ABSTRACT

A method and apparatus for processing work materials, the method including the steps of applying substantially into direct contact with the work material a substance operable to promote decomposition of the work material; distributing the work material bearing the substance on a surface disposed for decomposition; and an apparatus for practicing the method having an assembly operable substantially to fragment the work material.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field Of The Invention

The present invention relates to a method and apparatus for processing work materials and, more particularly, to such a method and apparatus which are particularly well suited to the processing of materials, which would otherwise be considered waste materials, for useful purposes.

(2) Description Of The Prior Art

The production of virtually all materials, products and the like, as well as, more specifically, in farming, construction and a multiplicity of other operations, inherently produces waste materials as a byproduct. These byproducts, in some cases, can be employed for other uses, or recycled in many ways.

In most instances, however, these byproducts cannot, as a practical matter, be used for secondary purposes. In these cases, which are most prevalent, disposal of the byproducts is the only option conventionally available. If not continuously managed, such byproducts accumulate creating an unacceptable burden. Accordingly, disposal of the byproducts by any available means is the norm. Most commonly, such disposal is by various types of incineration of the waste materials. These methods of disposal themselves commonly produce byproducts which are unacceptable, unhealthy and may, in fact, be illegal.

For example, in agriculture, the harvesting of a crop leaves residual materials which must be removed, or otherwise destroyed, before the next crop can be planted. This is the case, for example, with field crops such as rice, wheat, barley, oats, corn, potatoes, tomatoes and many other such crops. Using a specific field crop as a representative example, in the growing of rice plants, of course to produce rice as the harvested crop, residual materials remain in the field after harvest and conventionally present an obstacle to the planting and growing of the next season's rice plants. Such residual materials remaining after harvest include rice straw cuttings, rice stubble and other organic waste materials.

The conventional methods for eradicating such residual materials include incineration, or burning, of the waste materials remaining in the harvested field. These methods may rid the field of some, or substantially all, of the byproducts, but are otherwise unsatisfactory for consequential reasons. They may eradicate the waste materials which are exposed above-the soil. However, such action generally does not dispose of those organic materials at or below the exposed surface of the field. Additionally, burning of the waste materials, either as collected in an area assigned for this purpose, or in place, produces air pollution and other detrimental effects in the form of smoke, heat, airborne embers, air borne particulate matter and the like. They are also hazardous such as by the spreading of unintended and uncontrolled burning beyond the site, damage to equipment on the site and the like.

In part, because of these adverse consequences and others, governmental agencies have restricted the conditions under which such disposal is permitted. These conditions are being increasingly limited by law and regulation. Furthermore, detection and location of such burning operations requires little attention due to the high visibility of the plume of smoke arising above the site at the time of such incineration. Therefore, prohibited disposal of such materials without detection is highly unlikely.

Notwithstanding these facts, no other practical method for eradicating such unwanted residual organic materials has heretofore been found. While it is known to use farm implements such as discs, plows and mowers to breakup and/of turn the materials under the soil in an effort to render the soil of the field suitable for planting the next crop, this procedure has been unsatisfactory for innumerable reasons. These waste materials, whether beneath the surface or remaining on the surface, nonetheless interfere with or actually prevent planting of some of the next season's plants. This is largely due to the fact that these materials are quite resistant to decomposition and, in fact, cannot decompose between growing seasons. In the case of rice, for example, silica contained in the outer layers of the residual materials are quite resistant to decomposition.

Furthermore, alternatively, the conversion of such waste materials to other beneficial uses has not successfully been achieved.

Therefore, it has long been known that it would be desirable to have a method and apparatus for processing work materials which are particularly useful in the disposal of waste materials; which avoid the need to use prior art methods which are unsatisfactory for a variety of reasons; which permit the disposal of waste materials without producing adverse effects which may be harmful to the environment or otherwise unacceptable; which allow rapid conversion in place of waste materials to a variety of beneficial uses; which not only substantially eradicate the waste materials but, actually, in the process, enhance the growth and productivity of the site; and which are otherwise entirely successful in achieving their operational objectives.

### BRIEF SUMMARY OF THE INVENTION

Therefore, it is an object of the present invention to provide an improved method and apparatus for processing work materials.

Another object is to provide such a method and apparatus which have application to a wide variety of useful applications in the processing of work materials.

Another object is to provide such a method and apparatus which are particularly useful in the disposal of waste materials.

Another object is to provide such a method and apparatus which can be used to perform innumerable functions including converting waste materials into beneficial uses.

Another object is to provide such a method and apparatus which have particular utility in the eradication of unwanted residual materials in farming operations and the like.

Another object is to provide such a method and apparatus which can rapidly and dependably be employed in farming operations between growing seasons to perform their various functions so that the planting soil is prepared for planting in the subsequent growing season without detrimental effect.

Another object is to provide such a method and apparatus which can be employed to accomplish their various beneficial effects substantially without detrimental consequences and at a cost entirely consistent with their respective environments of usage.

Another object is to provide such a method and apparatus which possess a dependability of usage as to be readily employed without a substantial investment in the initiation of the use or maintenance required.

Another object is to provide such a method and apparatus which can be applied for usage without a significant period of training.

Further objects and advantages are to provide improved elements and arrangements thereof in a method and apparatus for the purposes described which are dependable, economical, durable and fully effective in accomplishing their intended purposes.

These and other objects and advantages are achieved, in the preferred embodiment of the present invention, in a method for processing work materials, the method including the steps of applying substantially into direct contact with the work material a substance operable to promote the decomposition of the work material; and distributing the work material bearing the substance rapid and progressive decomposition.

### BRIEF DESCRIPTION OF THE SEVERAL VIEWS OF THE DRAWINGS

FIG. 1 is a top plan view of the first embodiment of the apparatus of the present invention shown being transported in earth traversing movement by a vehicle, the apparatus being operable in the practice of the method of the present invention hereinafter set forth.

FIG. 2 is a side elevation of the apparatus of the present invention viewed in FIG. 1.

FIG. 3 is a somewhat enlarged, fragmentary transverse vertical section of the apparatus taken on line 3-3 in FIG. 1.

FIG. 4 is a side elevation of a second embodiment of the apparatus of the present invention shown being transported in earth traversing movement, the apparatus being operable in the practice of the method of the present invention hereinafter set forth.

FIG. 5 is a schematic diagram depicting the method of the present invention.

### DETAILED DESCRIPTION OF THE INVENTION

The method and apparatus of the present invention are hereinafter described in detail. For illustrative convenience, the method of the present invention is first set forth.

### Method

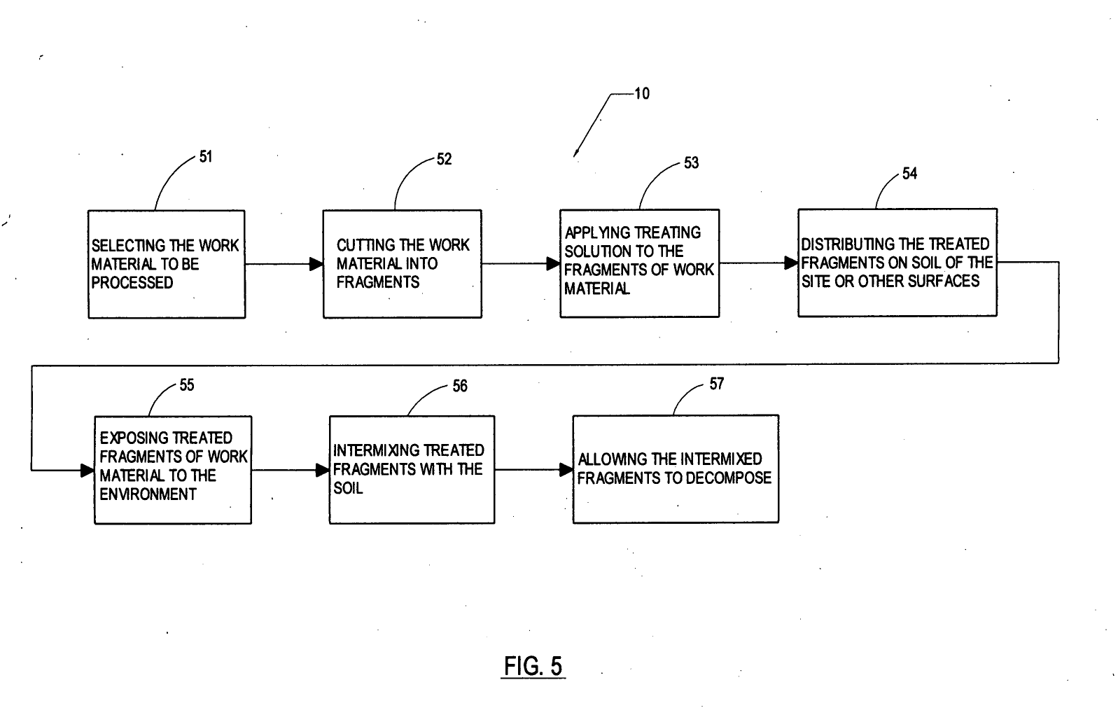

Referring more particularly to the drawings, the method for processing work materials of the present invention is depicted schematically in FIG. 5 and generally indicated by the numeral 10. For purposes of describing the method of the present invention, certain environmental conditions representative of those in which the method can be practiced are hereinafter identified in the several views of the drawings attached hereto and made a part hereof.

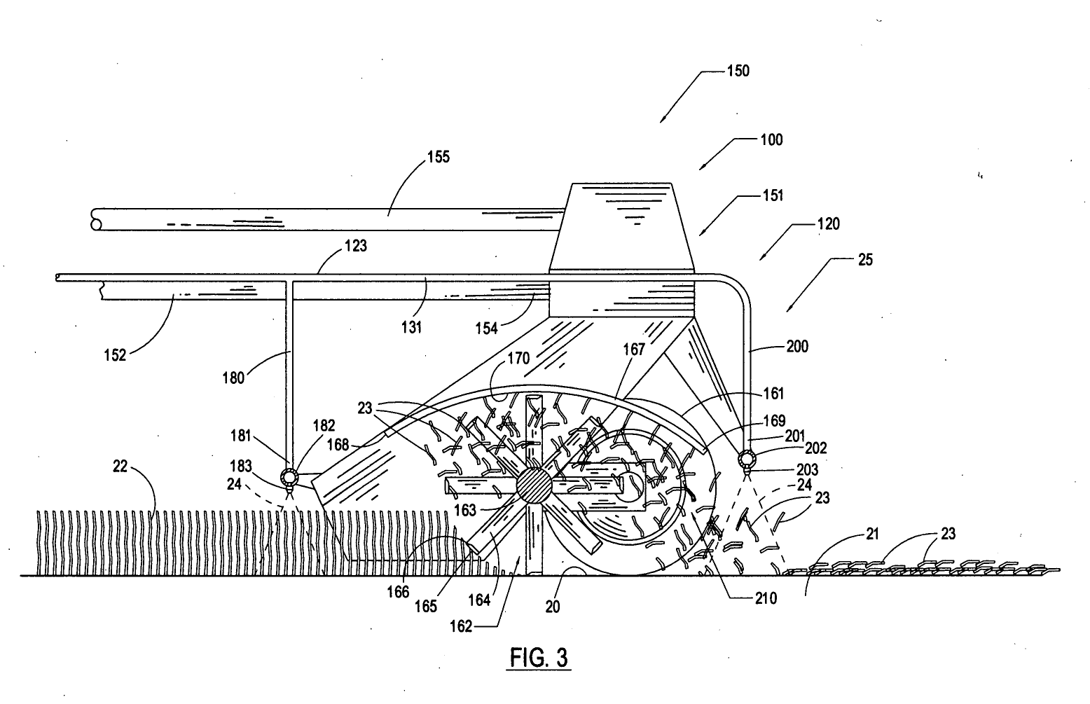

The earth surface is generally indicated by numeral 20. The earth surface, in a representative environment of use, is understood, for illustrative convenience, to be that of a field. The soil below the earth surface is indicated, in general, by the numeral 21. As best shown in FIG. 3, work material 22 extends generally upwardly from the earth surface. The work material, for illustrative convenience in this environment, is considered to be rice straw, rice straw cuttings, rice plants and other waste material. For the reasons heretofore discussed, it is desired to dispose of the work material.

Use of the method of the present invention, produces fragments 23 of the work material 22. The fragments are treated with a solution 24 in accordance with the method hereof. The environment in which the invention is practiced is generally indicated by the numeral 25.

The work material upon which the method is used can be any of a wide variety of types such as, for example, rice, wheat, barley, oats, corn, potatoes, tomatoes and many other materials. However, the method has been found to have particular utility where the work material is rice straw, rice straw cuttings, other residual materials remaining after harvest which are quite resistant to decomposition. Accordingly, for illustrative convenience and as previously noted, the specific work material to which reference is made herein will be understood to be rice straw, rice straw cuttings, rice plants, and other residual material remaining in the field after harvesting of the rice therefrom.

The harvesting of rice as a crop inherently leaves waste material or residue which subsequently interferes with normal farming operations. Such subsequent farming operations include, but are not limited to, preparing for and planting the next season's crop. This waste material includes the remaining rice straw cuttings from the harvesting of the crop, rice stubble, remaining rice plants, rice itself which remains from such harvesting and other such residue. These waste or work materials 22 are particularly resistant to eradication for a number of reasons including that the outer layers of this material contain a molecular structure which includes silica, the dioxide of silicon. These outer layers operate as a barrier to conventional methods, fluid treatments and equipment which would otherwise assist in breaking down such waste materials.

The most common means by which such waste materials are disposed of is by incineration, or the burning, of these materials in place. The sole object in such prior art disposal is to eradicate the material. This prior art method provides no beneficial result beyond this single objective and is not, in any case, entirely effective in achieving this objective. In addition, this prior art method results in a host of adverse consequences, including those previously set forth.

In contrast therewith, the method of the present invention not only eradicates the work material, but also produces a plurality of beneficial results and uses for the resulting material.

In accordance with the method of the present invention 10, the solution 24 is applied to the work material 22. For purposes of illustrative convenience, except as otherwise set forth herein, the term “solution” is used to indicate any of a variety of solutions, substances and the like employed in the practice of the method of the present invention. Some preferred examples of such solution are hereinafter set forth.

As shown in the following examples, the solution 24 is applied to the work material 22 so as, to the extent possible, completely to cover all exterior portions, or surfaces, of the work material. The solution is placed in direct contact with the work material. Where the work material is rice straw, the objective is to place the solution in direct contact with the rice straw plants, rice straw cuttings, rice and any other residual material remaining in the field after the harvesting operation. This process, using such solutions as hereinafter set forth, has been found to penetrate the outer layers of the rice straw and other work material to promote decomposition of the work material. The solution penetrates the silica in these outer layers so as to be absorbed into the materials as well as thus to permit the absorption of other natural substances which are present in the soil 21 or otherwise in the environment. The natural substances and conditions which may be present in the environment 25 are too numerous fully to catalogue, but include; for example, moisture, water, minerals and other substances present in the soil; sun light, temperatures, both hot and cold, and other weather conditions; remaining fertilizers, insecticides and herbicides; and other conditions which may or may not otherwise be undesirable. Various microorganisms, pests, and other substances are normally prevented from absorption into rice straw by the outer silica bearing layers of the rice straw.

In addition, it has been found that preliminary, simultaneous and/or subsequent processing of the work material 22 significantly enhances the decomposition of the work material. The method of the present invention includes fragmentation, cutting and/or otherwise finely dividing the work material.

Additionally, the method of the present invention encompasses the addition of other substances to the solution 24 or by separate application before, during, or after the application of the solution. Such additional substances include, for example, nitric acid, phosphoric acid, sulfuric acid as well as acid based fertilizers.

Still further, enzymes, various organisms and the like can be used with or without use of the above-identified substances.

The method by which the solution and/or other substances can be applied to the work material 22 include a wide variety of alternatives in addition to, or in substitute for, the apparatus of the present invention hereinafter set forth. These alternative forms of application include, for example, aerial spraying; irrigation; that is, by adding the solution to the irrigation water and flooding of the field therewith; spraying by boom spray equipment; and the like.

In all of these methods of application, the resulting acceleration of the process of decomposition of the work material 22 is substantial and otherwise significantly rapid in producing its other beneficial results. These beneficial results include, for example, substantial reduction in air pollution by the avoidance of the prior art method of eradication by burning or incineration; increased crop production in subsequent growing seasons; reduction of diseases which result using prior art techniques; reduction of pest infestations; eradication of conditions which lead to such pest infestations such as pest eggs, embryos and hibernating pests; a substantial increase in the organic composition of the soil; and aeration of the soil improving the conditions for subsequent plant growth and acceptability to other agricultural treatment and farming operations.

The method can also be employed to achieve other objectives such as using the resulting decomposed waste material 22 as a fuel source. In such cases, the material resulting from the practice of the method can be collected from the site and delivered to energy producing power plants. The resulting waste material can be converted for a myriad of other uses having value in the marketplace.

### EXAMPLE NO. 1

The first representative example of the practice of the method of the present invention can, perhaps, best be understood by first more specifically identifying the environment 25 of use.

The environment 25 of use of Example No. 1 is a field, or acreage, where rice has been grown. The condition of the field in which the rice has been grown is that immediately following harvesting of the rice from the plants thereof. The field most accurately can be visualized as being substantially completely littered with rice straw, rice straw cuttings, residual rice released during the harvest; rice plants partially below and extending above the field surface in the form of rice straw stubble and the like; and other waste materials and residue.

Using the apparatus of the present invention, or a similar implement, such as a swather, flail type mower, or the like, the field is traversed in paths extending over substantially the entire area to mow down or cut the rice straw stubble, rice straw cuttings, and other residual material, as depicted in FIG. 3. This step of the method finely cuts the rice straw into fragments 23 for subsequent processing in accordance with the method of the present invention. The rice straw fragments are discharged from the rear of the apparatus, with respect to the direction of travel of the apparatus in traversing the field.

In the case of the apparatus of the present invention, the cut, or severed, fragments 23 of rice straw are discharged along a rearward path in a substantially continuous flow, or stream, in which the fragments are contained and are generally spaced from each other, as shown in FIG. 3. The stream of fragments itself is preferably slightly elevated from the surface of the field at the point of discharge, again as shown in FIG. 3. The fragments fall gravitationally onto the earth surface 20 of the field.

In the case of use of the apparatus of the present invention, at the general location of the point of discharge, a treatment solution 24 of the method of the present invention is sprayed on to or otherwise applied to the rice straw fragments. In this Example No. 1, the treatment solution is in fluid, or liquid, form. It is sprayed downwardly from above the fragment stream and rearwardly of the mower so as substantially to cover the surfaces of all of the fragments in the stream with the treatment solution.

The treatment solution 24 of Example No. 1 is formulated from a nitrate-urea solution and fulvic acid to produce the first application solution. The first application solution is formulated within a range of substantially not less than a one to one (1:1) ratio nor substantially not more than a twenty to one (20:1) ratio. In both cases, the first number of the ratio represents the nitrate-urea solution and the second number represents the fulvic acid. The preferred rate of Example No. 1 is substantially about five (5) parts nitrate-urea solution and one (1) part fulvic acid. In the preferred formulation, the nitrate-urea solution provides thirty-two percent (32%) of the total nitrogen also known as “UN-32.” The one (1) part flvic acid solution is preferably of a strength of substantially about 75 percent (75%). The treatment solution of Example No. 1 applied to the fragments of rice straw is preferably, although not necessarily, applied at a rate of substantially about twenty (20) gallons per acre of the field being processed. The solution of Example No. 1 has been found to penetrate the silica of the outer layers of the work material 22, or in other words, the waste materials. This penetration promotes the rapid and progressive breakdown of the waste materials. In addition, this allows the waste materials to absorb other substances and to be affected by conditions which contribute to the rapid decomposition of the waste materials.

In accordance with the method of Example No. 1, when the entire field has been processed, as above described, the fragments 23 of rice straw so treated are distributed on to the field in rested relation on the earth surface 20 and soil 21 thereof. In the manner of fragmenting, treating and distributing the rice straw fragments, the fragments substantially cover the earth surface and soil of the field. In accordance with the method of the present invention, the fragments can promptly thereafter be disked or turned under the earth. Alternatively, the fragments can be left exposed to the environment 25 for a given period of time. This exposure, for example, exposes the fragments to sun light, both high and low ambient temperatures, moisture, water, rain, wind and other weather conditions, substances and conditions in the soil and the like. These conditions can interact with the treatment solution on the fragments to initiate and rapidly cause the decomposition, or breakdown, of the rice straw fragments.

In accordance with the method of the preferred embodiment of the present invention, within substantially about twenty-four (24) hours after such distribution of the fragments 23, it is preferable, although not required, further to process the fragments. This step calls for the fragments to be turned into and thus intermixed with the soil 21. Using an implement such as a disk, disk harrow, or the like, the field bearing the fragments on the soil thereof is traversed in paths to so process the entire area of the field. This process intermixes the treated fragments with the soil further to promote the decomposition of the rice straw fragments in the field. The direct contact of the treated fragments with moisture and water in the soil, other substances contained in the soil, the denial of light and the treatment solution interact to promote accelerated decomposition. This has been found to promote decomposition of the waste material so as to produce usable organic matter in the soil, reduce pest infestations, increase crop production and other beneficial effects while ridding the field of the waste material.

The field and the soil thereof can thereafter be handled, or husbanded, in accordance with normal farming practices. The next season's crop is, in summary, relieved of the adverse presence of the waste material while receiving all of the beneficial results of the practice of the method hereof.

### EXAMPLE NO. 2

In the second representative example of the practice of the method of the present invention, for illustrative convenience, is set forth herein in the same environment 25 of use as discussed relative to Example No. 1 hereof.

Thus, the environment 25 of use of the second example is a field, or acreage, where rice is grown. The condition of the field in which the rice has been grown is that immediately following harvesting of the rice. The field is thus littered with rice straw, rice straw cuttings, residual rice released during the harvest; rice plants partially below and extending above the field surface in the form of rice straw stubble and the like; and other residue all of which must be disposed of, or otherwise dealt with, in such a manner as not to impede subsequent plantings.

The apparatus of the present invention, hereinafter discussed in greater detail, or an implement, such as a swather, operable for the same, or a similar purpose, is operated in the field. The field is traversed in paths extending over substantially the entire area to mow down or otherwise cut the rice straw stubble, rice straw cuttings, and other residual material, as depicted in FIG. 3. This step of the method finely cuts the rice straw and other residual material into fragments 23 for subsequent processing. The rice straw fragments are discharged from the rear of the apparatus with respect to the direction of travel of the apparatus along the path of cutting the rice straw. As noted, these paths extend over the entire area in which such waste material exists.

In the case of the apparatus of the present invention, the cut, or severed, fragments 23 of rice straw are discharged along a rearward path in a substantially continuous flow, or stream, in which the fragments are contained and are generally spaced from each other, as shown in FIG. 3. The stream of fragments itself is preferably slightly elevated from the surface of the field at the point of discharge, again as shown in FIG. 3. The fragments are thus gravitationally released onto the surface of the field.

In the case of use of the apparatus of the present invention, at the general location of the point of discharge, a treatment solution of the method hereof is sprayed on to, or otherwise applied to, the rice straw fragments. In this Example No. 2, the treatment solution is in fluid, or liquid, form. It is preferably sprayed downwardly from above the fragment stream so as substantially to cover all of the surfaces of all of the fragments in the stream with the treatment solution.

The treatment solution 24 of Example No. 2 is formulated from a nitrate-urea solution and humic acid to produce the solution of Example No. 2. The second application solution is formulated within a range of substantially not less than a one to one (1:1) ratio nor substantially not more than a twenty to one (20:1) ratio. In both cases, the first number of the ratio represents the nitrate-urea solution and the second number represents the humic acid. The preferred rate of Example No. 2 is substantially about five (5) parts nitrate-urea solution and one (1) part humic acid. In the preferred formulation, the nitrate-urea solution provides thirty-two percent (32%) of the total nitrogen also known as “UN-32.” The one (1) part humic acid solution is preferably of a strength of substantially about 8 percent (8%). The treatment solution of Example No. 2 applied to the fragments of rice straw is preferably, although not necessarily, applied at a rate of substantially about twenty (20) gallons per acre of the field being processed. The solution of Example No. 2 penetrates the silica of the outer layers of the waste materials. This penetration promotes the rapid breakdown of the waste materials. In addition, this allows the waste materials to absorb other substances and to be affected by conditions which accelerate the decomposition of the waste materials.

In accordance with the method of Example No. 2, when the entire field has been processed, as above described, the fragments 23 of rice straw so treated are distributed on to the field in rested relation on the earth surface 20 and the soil 21 thereof. In the manner of fragmenting, treating and distributing the rice straw fragments, the fragments substantially cover the soil of the field and are thus exposed to the environment 25. This, for example, exposes the fragments to sun light, both high and low ambient temperatures, water, rain, wind and other weather conditions, substances and conditions in the soil, and the like. These conditions in the environment interact with the treatment solution covering the fragments to initiate and rapidly cause the decomposition, or breakdown, of the rice straw fragments.

In accordance with Example No. 2, substantially within about twenty-four (24) hours after such distribution of the fragments 23, it is preferable, although not required, further to process the fragments. This step calls for the fragments to be turned into and thus intermixed with the soil 21. Using an implement such as a disk, disk harrow, or the like, the field bearing the rice straw fragments on the soil thereof is traversed in paths to so process the entire area of the field. This step intermixes the treated fragments with the soil further to promote the decomposition of the rice straw fragments in the field. The direct contact of the treated fragments with moisture and water in the soil, other substances contained in the soil, the denial of light and the treatment solution interact to promote decomposition. This has been found to create decomposing organic matter in the soil, to reduce pest infestations, to increase crop production and produce other beneficial effects while ridding the field of the waste material.

For purposes of further illustrating the practice of the method of the subject invention, attention is invited to FIG. 5 hereof. As previously noted, FIG. 5 is a schematic diagram of the steps of the preferred embodiment of the method of the subject invention. In view of the detailed description above, the steps of FIG. 5 are briefly summarized.

The first step 51 is selecting the work material to be processed. In the illustrative examples herein provided, the work material is rice straw waste material.

The second step 52 is that of cutting the work material into fragments. In the illustrative examples, this step is performed using the apparatus of the present invention, or any other suitable implement.

The third step 53 is that of applying treating solution to the fragments of work material. This step can be performed using the apparatus of the present invention, or by any other suitable means such as heretofore set fourth.

The fourth step 54 is that of distributing the treated fragments on the soil of the site or other surface.

The fifth step 55 is that of exposing the treated fragments of work material to the environment.

The sixth step 56 is that of intermixing the treated fragments with the soil.

The seventh step 57 is that of allowing the intermixed fragments to decompose in the soil.

With both Example No. 1 and Example No. 2, as well as other embodiments of the method hereof, a surfactant or nutrient solution consisting of a humectant solution, such as, for example, molasses or dextrose, can be applied to the fragments during the application of the solution to the fragments, in other words, intermixed with the solution. This can also be done separately before or after the application of the solution 24. The surfactant operates more aggressively to retain the solution in direct contact with the fragments so as to enhance the solution's effect. This accelerates the biodegradation process. It is preferably, although not necessarily applied at the rate of approximately 1.5 gallons per acre.

Further, the method of the present invention encompasses the use of other substances applied to the fragments before, during, or after application of the solution to the fragments. For example, it has been found beneficial to so apply acid based fertilizers, such as nitric acid, phosphoric acid, sulfuric acid and/or the like to the fragments to enhance the decomposition thereof.

Still further, one or more additives such as pesticides, herbicides, fungicides and the like can also be applied to the fragments 23 and/or the field before, during, or after the application of the solution.

The field and the soil thereof can thereafter be handled, or husbanded, in accordance with normal farming practices. Thus, the next season's crop is, in summary, relieved of the adverse presence of the waste material while receiving all of the beneficial results of the practice of the method hereof.

### Apparatus

### First Processing Apparatus

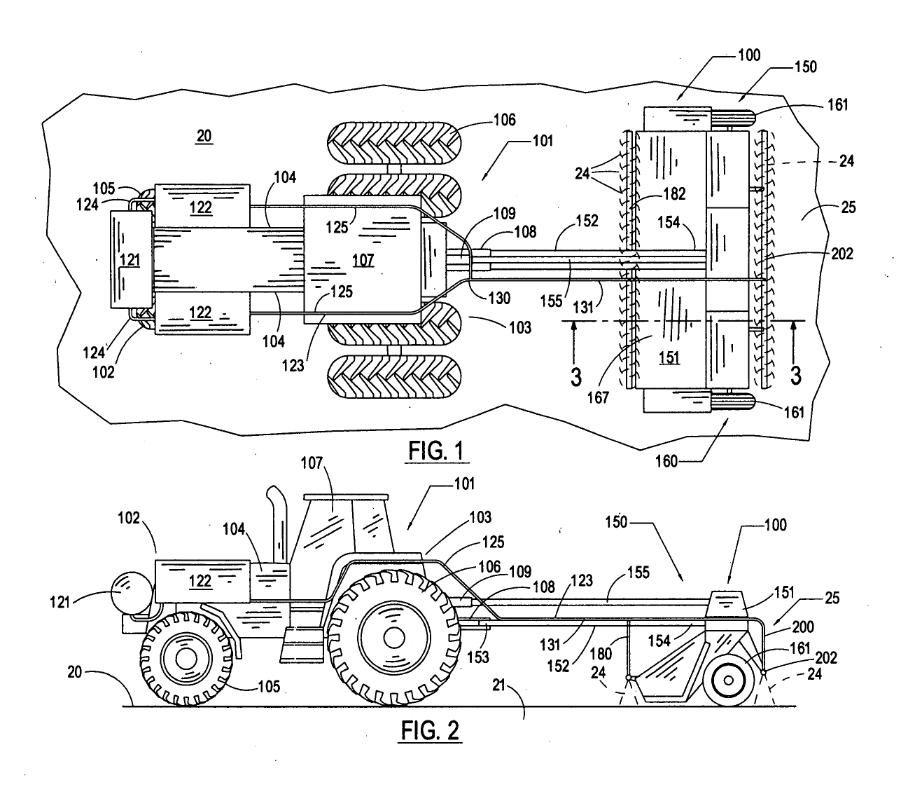

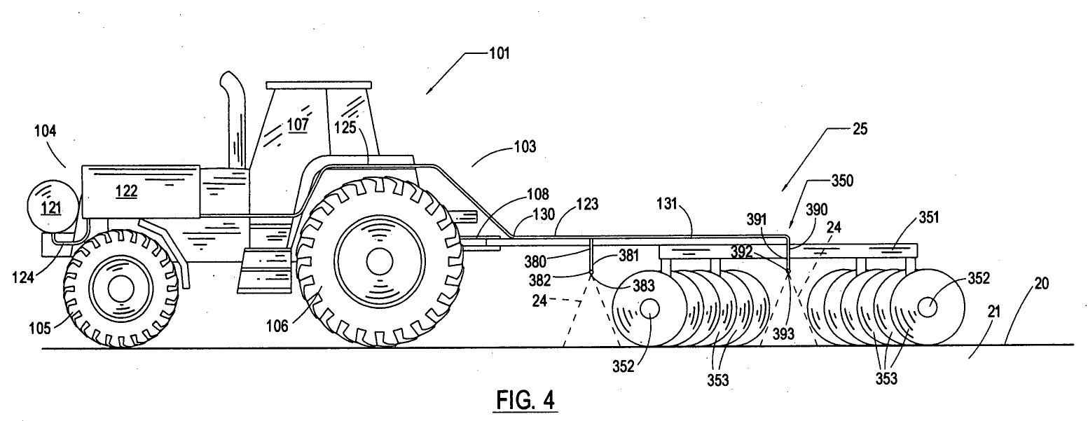

The first processing apparatus of the present invention is generally indicated by the numeral 100 and is shown in FIGS. 1, 2 and 3. The apparatus will be identified as such as well as the first processing implement. FIG. 4 shows a second processing apparatus, or second processing implement, of the present invention. Both apparatuses are useful in the practice of the method of the present invention.

As shown in FIG. 1, the first processing apparatus 100 is drawn, or pulled, by a vehicle, or tractor, 101. The tractor has, generally, a front portion 102 and an opposite rear portion 103. The tractor has opposite side portions 104 and is supported for earth traversing movement by front wheels 105 and rear wheels 106. The tractor has a cab assembly 107 from which the tractor is driven. The tractor has a tool bar 108 mounted on the rear portion of the tractor which is adapted to have implements attached thereto for pulling or towing during operation. A drive mount 109 is mounted on the rear portion of the tractor and is operable selectively to transmit rotational movement to a drive line attached thereto.

A spray system, generally indicated by the numeral 120, is mounted on the tractor 101. The spray system has a front tank 121 which is mounted on the front portion 102 of the tractor 101 extending transversely thereof, as best shown in FIG. 1. A pair of side tanks 122 are individually mounted on the opposite side portions 104 of the tractor. The spray system has a fluid conduit system 123 which is mounted in fluid receiving relation on the front tank and side tanks. The front tank is connected in fluid supplying relation individually to the side tanks 122 by first conduits 124. Second conduits 125 are individually connected to the side tanks in fluid receiving relation. The second conduits extend rearwardly to the rear portion 103 of the tractor and are joined at a junction 130 in fluid supplying relation. A third conduit 131 is connected in fluid receiving relation to the junction and extends rearwardly therefrom, as will hereinafter be described in greater detail. Alternatively, the apparatus can employ a “nurse tank” to carry the solution 24.

The spray system 120 has a pressurizing system, or pump assembly, not shown, operable to pump fluid, for example the solution 24, from the front tank 121 and side tanks 122 through the spray system from left to right, as viewed in FIGS. 1, 2 and 3.

The apparatus 10 has a processing implement 150 shown in FIGS. 1, 2 and 3. The implement has a main frame 151 on which is mounted and forwardly extended therefrom a draw bar 152. The draw bar has a forwardly extending tongue 153, adapted releasably to be mounted on the tool bar 108, and an opposite rear portion 154. The implement has a drive shaft 155 releasably mounted at one end thereof in driven relation on the drive mount 109 and an opposite end mounted on and in driving relation to the processing implement.

The processing apparatus 150 is borne for earth traversing movement on a wheel assembly 160 having a pair of ground engaging wheels 161. The main frame 151 mounts a flail or cutting assembly 162 having a main drive shaft 163 extending transversely of the processing implement just inwardly of the wheels 161. The drive shaft is driven in rotational movement in a clockwise direction, as viewed in FIG. 3. A plurality of cutting members 164 are mounted on and extend radially outwardly from the drive shaft for rotation thereby in the clockwise direction, as viewed in FIG. 3. Each of the cutting members mounts a cutting blade 165 at the terminus thereof having a cutting edge 166. The cutting members are mounted on and extend in spaced relation to each other substantially the complete length of the drive shaft.

An arcuate housing, or shield, 167 is mounted on the main frame 151 of the processing implement 150 and extends transversely thereof above the cutting assembly 162. The shield has a leading edge 168 and an opposite trailing edge 169. The shield has an arcuate lower surface 170 which is spaced just upwardly from the cutting assembly 162 to provide clearance therefore.

The apparatus 100 is driven by the drive shaft 155 from the drive mount 109 of the tractor 101. More specifically, the cutting assembly 162 is driven in clockwise rotation, as viewed in FIG. 3, from the drive shaft 155 by means of a suitable transmission, or drive line, not shown, within the processing implement.

The third conduit 131 of the spray system 120 of the apparatus 100 has a primary conduit 180 extending downwardly from the third conduit 131 in fluid receiving relation therefrom to a terminal end 181. The terminal end communicates in fluid supplying relation to a first transverse conduit 182. The first transverse conduit extends substantially the full length of the implement, as shown in FIG. 1. A plurality of spray nozzles 183 are mounted on the first transverse conduit in spaced relation to each other and operable, when pressurized, to spray the solution 24 downwardly toward the earth surface 20 and work material 22 such as heretofore identified. The solution so applied thus extends substantially the entire width and ahead of the implement with respect to the direction of travel.

A secondary conduit 200 is mounted on the third conduit 131 in fluid receiving relation. The secondary conduit has a terminal end 201 extending downwardly to the position shown in FIG. 3. A second transverse conduit 202 is mounted on the terminal end of the secondary conduit and extends transversely of the implement substantially the full width thereof. The first transverse conduit 182 and second transverse conduit 202 are substantially parallel to each other. A plurality of spray nozzles 203 are mounted on the second transverse conduit in space relation to each other and are operable to spray the solution 24 in a generally downwardly facing direction. The first transverse conduit and second transverse conduit are both sealed at both ends thereof permitting them to be pressurized with, for example, the solution 24.

As best shown in FIG. 3, the second transverse conduit 202 defines with the earth surface 20 a spray passage 210 therebetween.

### Second Processing Apparatus

The second processing apparatus of the present invention is referred to herein as such as well as the second processing implement. The second processing implement is employed in the practice of the method of the present invention as an alternative to, or in substitute for, the first processing apparatus 100 and in other usages is identified by the numeral 350 and is shown in FIG. 4. Except as hereinafter noted, the second processing implement is drawn, or pulled, by a vehicle, or tractor, 101 as in the case of the apparatus 100. In the preferred embodiment, the second processing implement is drawn by a tractor which is identical to the tractor 101.

The second processing implement is generally indicated by the numeral 350 therein. The second processing implement, as shown in FIG. 4, is, in large part, a disk harrow of conventional construction, except as hereinafter described. Thus, the second processing implement generally has a main frame 351 having a pair of axle assemblies 352 each mounting a plurality of disks 353. In the conventional manner, when the disk harrow is drawn by the tractor 101 over the earth surface, or field, 20, the soil 21 is cut into, or sliced, by the disks to a desired depth and turned over to intermix the soil with material laying on, or otherwise contained, in the soil. The depth of such slicing is selected by mounting the effective number of weights, not shown, thereon to cause the disks to penetrate soil to the desired depth. The result of this disking, or plowing operation is, to a substantial extent, bury the material beneath the soil leaving only vestiges of the material exposed.

The second processing implement 350 is otherwise believed to be novel, as hereinafter described. Similar to the first processing implement 100, the second processing implement has a spray system 120. The spray system has a front tank 121 and a pair of side tanks 122. The spray system has a fluid conduit system 123 having a pair of first conduits 124 mounted in fluid supplying relation to second conduits 125. The second conduits are joined at a junction 130 in fluid supplying relation to a third conduit 131. Alternatively, the second processing implement can employ a “nurse tank” to carry and supply the solution 24 to the spray system.

The second processing implement 350 has a first conduit 380 mounted in fluid receiving relation on the third conduit 131 and extends downwardly to a terminal end 381. The terminal end is mounted in fluid supplying relation to a first transverse conduit 382. Preferably, although not necessarily, the first transverse conduit extends substantially horizontally the width of the second processing implement as in the case of the first transverse conduit 182 of the first processing implement 100. A plurality of spray nozzles 383 are mounted on the first transverse conduit 382 in spaced relation therealong and facing downwardly in fluid discharging relation. As shown in FIG. 4, the first transverse conduit, and the spray nozzles borne thereby, are positioned forwardly of the first axle assemblies 352 and disks 353 with respect to the normal forward direction of travel of the second processing implement from right to left, as viewed in FIG. 4.

A second conduit 390 is mounted on and extends downwardly from the distal end of the third conduit 131. The second conduit extends downwardly to a terminal end 391 which, in turn, is mounted on a second transverse conduit 392 in fluid supplying relation thereto. Preferably, although not necessarily, the second transverse conduit 392 extends substantially horizontally the width of the second processing implement. A plurality of spray nozzles 393 are mounted on and face downwardly from the second transverse conduit in fluid discharging relation. The second transverse conduit 392 and the spray nozzles thereof are positioned in front of the rearward axle assemblies 352 and disks 353. Thus, the second transverse conduit 392 and the spray nozzles 393 are positioned between the forward axle assemblies and the disks thereof and the rearward axle assemblies and disks, as shown in FIG. 4.

### Operation

The operation of the first form of the apparatus of the present invention 100 and the operation of the apparatus of the second form of the present invention are believed to be readily apparent and are briefly summarized at this point.

It will first be recognized that the first form of the apparatus 100 and second form of the apparatus 350 are intended to be operated alternatively to each other in the practice of the method of the present invention in both Examples No. 1 and No. 2 as well as in the practice of other methods. Thus, either the first form of the apparatus 100 is used or the second form of the apparatus 350 is used. However, the first and second forms of the apparatus can, if desired, be employed in sequence both in the practice of the method heretofore set forth as well as in the practice of other methods.

For illustrative convenience, the description of the first and second form of the apparatus will be described in use in the practice of both Example No. 1 and Example No. 2 of the method hereof.

The first form of the apparatus 100 is attached to the vehicle, or tractor, 101 in draft, or towed, relation thereto, as shown in FIGS. 1, 2 and 3. It will be understood that the normal forward direction of travel is from right to left, as viewed in FIGS. 1, 2 and 3. Before such drafting movement, the spray system 120 is connected in fluid supplying relation to the spray nozzles 183 and 203. The spray system is pressurized by the fluid pump, not shown, at the desired time to cause the solution 24 to be discharged through the spray nozzles in spray patterns shown. As shown in FIGS. 1, 2 and 3, the solution 24 is sprayed substantially the entire width of the first form of the apparatus and immediately forwardly of the apparatus and in trailing relation to the apparatus spraying in a downwardly facing relation.

As best shown in FIG. 3, the apparatus is drawn through the field and over the earth surface 20. As this takes place, the cutting assembly 162 is rotated in a clockwise direction, as viewed in FIG. 3. The cutting blades 165 sever, or cut, the work material 22 into fragments 23. The work material is first sprayed with the solution prior to being cut into fragments. The fragments are, subsequent to being cut into fragments, sprayed with the solution from above as they pass through the spray passageway 210. Thus, the work material 22 and the fragments 23 thereof are substantially entirely covered with the solution 24 as they are discharged on to the earth surface 20.

The apparatus 100 is, as described above, pulled in swaths over the work material 22 until the entire field 20, or the desired portion thereof, has been so processed. As a direct consequence thereof, the fragments 23, covered with the solution 24, are distributed into rested relation on the soil 21 over the entire earth surface 20 thereof. Similarly, the work material, or plant material, remaining in and extending above the soil 21 are similarly cut into fragments, and covered with the solution and exposed to the environment 25.

As heretofore discussed, the solution 24 causes the fragments and remaining plant material to begin to decompose as they are exposed to the elements.

Subsequently, in the preferred form of the present invention, a conventional disk harrow, or the like, not shown, is drawn over the soil 21 of the field previously traversed using the first processing implement 150. The preferred period of time between use of the first processing implement and such use of the conventional disk harrow is up to about one day, or twenty-four (24) hours. However, this period of time can be of any appropriate length.

During use of the second processing implement 350, the solution 24 is sprayed on the fragments 23 and remaining work material 22 using the spray nozzles 383. The sprayed solution is so applied just forwardly of the front and rear disks 353. Such use of the second processing implement turns the fragments and remaining work material under the soil 21 thus intermixing the fragments and work material with the soil and effectively burying it beneath the earth surface 20. This further enhances the decomposition of the fragments and work material, as heretofore set forth. In addition, the field is rendered suitable for subsequent use such as in the next growing season.

Therefore, the method and apparatus of the present invention provide a method and apparatus for processing work materials which are particularly useful in the disposal of waste materials; which avoid the need to use prior art methods which are unsatisfactory for a variety of reasons; which permit the disposal of waste materials at the site without producing adverse effects which may be harmful to the environment or otherwise unacceptable; which allow rapid conversion of the waste materials to a variety of beneficial uses; which not only eradicate the waste materials but, actually, in the process, enhance the growth and productivity of the site; and which are otherwise entirely successful in achieving their operational objectives.

Although the invention has been herein shown and described in what is conceived to be the most practical and preferred embodiments, it is recognized that departures may be made therefrom within the scope of the invention which is not to be limited to the illustrative details disclosed.

Having described our invention, what we claim as new and desire to secure by Letters Patent is:

1. A method for processing work materials, the method comprising the steps of:
applying substantially into direct contact with the work material a substance operable to promote the decomposition of said work material; and
distributing the work material bearing said substance in such a manner that the work material is disposed for decomposition.

2. The method of claim 1 including the step of:
fragmenting said work material, prior to said distributing step, to permit said substance to act upon the resulting fragments of the work material so as to promote the decomposition thereof.

3. The method of claim 2 wherein said applying step is approximately in conjunction with said fragmenting step.

4. The method of claim 3 wherein said distributing step includes the distribution of said fragments on soil and including the step of
intermixing the fragments with said soil after the distributing step.

5. The method of claim 4 wherein said substance of the applying step is a solution including an effective amount of nitrate-urea and fulvic acid.

6. The method of claim 5 wherein said solution includes substantially not greater than about five parts nitrate-urea and one part fulvic acid.

7. The method of claim 5 wherein said substance of the applying step is a solution including an effective amount of nitrate-urea and humic acid.

8. The method of claim 7 wherein said solution includes substantially not greater than about five parts nitrate-urea and substantially not greater than one part humic acid.

9. The method of claim 5 or claim 7 wherein said solution includes a fertilizer containing an acid.

10. The method of claim 9 including the step of
applying a surfactant to said fragments of the work material to enhance said decomposition thereof.

11. The method of claim 9 including the step of
applying a humectant solution to said fragments of the work material to accelerate the decomposition of the work material.

12. The method of claim 9 including the step of
applying an acid selected from a group consisting of nitric acid, phosphoric acid, sulfuric acid, and any other acid based fertilizer.

13. The method of claim 12 including the step of
applying at least one treating solution selected from a group consisting of a pesticide, herbicide, fungicide and any combination thereof.

14. The method of claim 13 wherein said applying step is performed using a flail type mower operable to fragment said work material and said mower has a spray system operable, in said applying step, to spray said solution on the fragments substantially simultaneously therewith.

15. The method of claim 14 wherein in said applying step the fragments of the work material are substantially covered with said solution.

16. The method of claim 15 wherein said work material includes rice straw cuttings resulting from the harvest of rice grown in said soil and including the step of
distributing said covered fragments of the rice straw cuttings on the soil.

17. A method for processing rice straw and the like to eradicate said rice straw and the like produced during the harvest of rice and the like grown in the soil of a field thereof, the method comprising the steps of:
fragmenting said rice straw using a mower to traverse said field to convert the rice straw into substantially finely divided fragments thereof;
applying, substantially during said fragmenting step, a solution, selected from a first group including nitrate-urea and humic acid or a second group including nitrate-urea and fluvic acid, on said rice straw;
distributing said fragments after the applying step on the soil of the field; and
subsequently intermixing the fragments with said soil to enhance the decomposition of said fragments.

18. The method of claim 17 wherein, during said applying step, substantially completely covering the fragments with said solution substantially to penetrate the rice straw to promote the decomposition thereof.

19. An apparatus for processing rice straw and the like for the substantial eradication thereof, the apparatus comprising frame adapted for earth traversing movement; a work assembly mounted on the frame operable to cut said rice straw into fragments thereof during said earth traversing movement; a fluid application system having fluid discharge means mounted on the work assembly in a predetermined position relative to the direction of travel of the work assembly during said earth traversing movement; and a source of fluid, operable to promote decomposition of the fragments, operably connected to said fluid application system in fluid supplying relation to said fluid discharge means to apply said fluid to the rice straw and the fragments thereof.

20. The apparatus of claim 19 wherein said work assembly is a mower.

21. The apparatus of claim 19 wherein said predetermined position is forwardly of the work assembly relative to the direction of travel.

22. The apparatus of claim 19 wherein said predetermined position is rearwardly relative to said direction of travel.
